(19) United States
(12) Patent Application Publication
(10) Pub. No.: US 2010/0228932 A1
(43) Pub. Date: Sep. 9, 2010

(54) METHOD OF TRANSFERRING AND ALIGNING OF INPUT DATA AND MEMORY DEVICE USING THE SAME

(76) Inventors: SEUNGJUN BAE, Hwaseong-si (KR); KWANGIL PARK, Yongin-si (KR); YOUNGSOO SOHN, Gunpo-si (KR)

Correspondence Address: MUIR PATENT CONSULTING, PLLC, 9913 Georgetown Pike, Suite 200, P.O. Box 1213, GREAT FALLS, VA, 22066, US

(21) Appl. No.: 12/718,242

(22) Filed: Mar. 5, 2010

(30) Foreign Application Priority Data
Mar. 9, 2009 (KR) 10-2009-0019949

(51) Int. Cl. G06F 12/00

(52) U.S. Cl. 711/154; 711/E12.001

(57) ABSTRACT

A method of transferring input data is disclosed. In one embodiment, during a burst having a burst length of N, the method comprises transferring to a memory device data for each of a plurality of unit intervals (UIs) of the burst through a plurality of terminals, wherein each of the transfers includes D bits of input data and at least some of the input data is to be written to the memory device. The method further comprises transferring to the memory device mask data during the burst as part of the input data, the mask data occupying at least two UIs, and transferring to the memory device content data during the burst as part of the input data, wherein the mask data transferred during each of the at least two UIs has the same value.

### CROSS-REFERENCE TO RELATED APPLICATION

This application claims the benefit of Korean Patent Application No. 10-2009-0019949, filed Mar. 3, 2009, the contents of which are incorporated herein by reference in their entirety.

### BACKGROUND

1. Field

Example embodiments relate to methods of transferring and aligning input data, and more particularly, to methods of transferring and aligning input data including mask data, and a memory device using the same.

2. Description of Related Art

In general, most semiconductor memory devices include a memory cell array of a matrix structure so that they store data into the memory cells or output data from the memory cells in response to a row address and a column address inputted along with a command from an external device. Recently, operating speed of semiconductor memory devices, such as DRAM, SRAM, Flash memory, etc., has increased, which results in increased performance of systems that include semiconductor memory devices. Consequently, processing speed for data being stored into memory devices has needed to increase as well. Accordingly, synchronous memory devices operating in synchronization with a system clock have been developed for high speed data transmission.

In addition, most memory devices have a data masking function that prevents specific data from being written to the memory cells and prevents the memory cells from being written to. For supporting the data masking function, conventional memory devices have at least one data mask pin DM, and mask specific data of input data in response to a mask indicating signal from that pin during a write operation. That is, when a write operation occurs, especially when there is no need to change data stored in specific memory cells, the mask data on the data mask pin DM prevents the specific memory cell from being written to in order to prevent any change in previously stored data.

As integration of memory devices becomes more prevalent, the conventional method of data mask operations having additional data mask pins creates a burden by increasing the number of pins of memory devices. Also the mask indication signal from the external device to memory devices in the conventional method of data mask operation is transferred at the same speed that of data to be written to the memory cells. As faster operation has been demanded, a greater possibility of error exists in transferring the mask indicating signal. If an error of mask data occurs, it may be very difficult to correct the problem caused by the error.

### SUMMARY

In one embodiment, a method of transferring input data is disclosed. During a burst having a burst length of N, the method comprises transferring to a memory device data for each of a plurality of unit intervals (UIs) of the burst through a plurality of terminals, wherein each of the transfers includes D bits of input data and at least some of the input data is to be written to the memory device. The method further comprises transferring to the memory device mask data during the burst as part of the input data, the mask data occupying at least two UIs, and transferring to the memory device content data during the burst as part of the input data, wherein the mask data transferred during each of the at least two UIs has the same value

In another embodiment, a method of aligning data to be stored in a memory device including a plurality of memory cells is disclosed. The method includes receiving input data including content data through a plurality of terminals during a plurality of Unit Intervals (UIs) comprising a burst length N, wherein the memory device is configured to receive both the content data and mask data through the same plurality of terminals. The method additionally includes determining if a write command indicates a data mask operation, and if the write command does not indicate a data mask operation, aligning the content data to be stored in N memory locations, and if the write command indicates a data mask operation, aligning the content data to be stored in fewer than N memory locations and aligning pre-set data for the remaining of the N memory locations.

In another embodiment, a memory device including a plurality of memory cells is disclosed. The memory device includes a data receiver configured to receive input data including mask data and content data during a plurality of Unit Intervals (UIs) of a burst, a data aligner configured to divide and align the input data into the mask data and the content data in response to a control signal indicating a write command, and a data re-aligner configured to receive the aligned mask data and the aligned content data and to realign the content data in response to the aligned mask data.

In a further embodiment, a memory system is disclosed. The memory system includes a controller configured to output data to Q terminals during N unit intervals (UIs) of a burst having length N to a memory device. The memory system further includes a memory device including memory cells. The memory device is configured to receive, through Q terminals during the burst, the data output from the controller, receive a control signal that indicates whether any of the data received at the Q terminals during the burst is mask data, based on the control signal indicating that none of the data received during the burst at the Q terminals is mask data, write all of the data received through the Q terminals during the burst to the memory cells.

### BRIEF DESCRIPTION OF THE DRAWINGS

Example embodiments are described in further detail below with reference to the accompanying drawings:

FIG. 1 shows a memory system according to one embodiment;

FIG. 2a is a timing diagram illustrating a timing sequence for a O-byte masking operation consistent with exemplary embodiments;

FIG. 2b is a timing diagram illustrating a timing sequence for a 1-byte masking operation consistent with exemplary embodiments;

FIG. 2c is a timing diagram illustrating a timing sequence for a multi-byte masking operation consistent with exemplary embodiments;

FIG. 3 shows an exemplary method of transferring input data including content data and no mask data in a memory system according to one embodiment;

FIG. 4a shows an exemplary method of transferring input data including mask data and content data in a memory system according to one embodiment;

FIG. 4b shows another exemplary method of transferring input data including mask data and content data in a memory system according to one embodiment;

FIG. 5a shows an exemplary method of transferring input data including mask data and content data in a memory system according to another embodiment;

FIG. 5b shows another exemplary method of transferring input data including mask data and content data in a memory system according to another embodiment;

FIG. 6 shows an exemplary method of transferring input data including mask data and content data for a multi-byte masking operation according to one embodiment;

FIG. 7a shows an exemplary method of transferring input data including mask data and content data for a 3-byte mask operation according to one embodiment.

FIG. 7b shows another exemplary method of transferring input data including mask data and content data for a 3-byte mask operation according to another embodiment;

FIG. 8a shows an exemplary data input part of a memory device in accordance with one embodiment;

FIG. 8b illustrates processes of data alignment consistent with certain disclosed embodiments;

FIG. 9 is a flow chart illustrating a method of aligning input data according to one embodiment;

FIG. 10 is a block diagram of a digital TV adopting a memory device according to one embodiment;

It should be noted that these figures are intended to illustrate the general characteristics of methods, structure, and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

Example embodiments will now be described more fully with reference to the accompanying drawings. Example embodiments may, however, be embodied in many different forms and should not be construed as being limited to the embodiments set forth herein. Rather, these embodiments are provided so that this disclosure will be thorough and complete, and will fully convey the concept of example embodiments to those of ordinary skill in the art.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items.

It will be understood that, although the terms “first”, “second”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, unless noted otherwise, a first element, component, region, layer or section discussed below could be termed a second element, component, region, layer or section without departing from the teachings of example embodiments.

The terminology used herein is for the purpose of describing particular embodiments only and is not intended to be limiting of example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

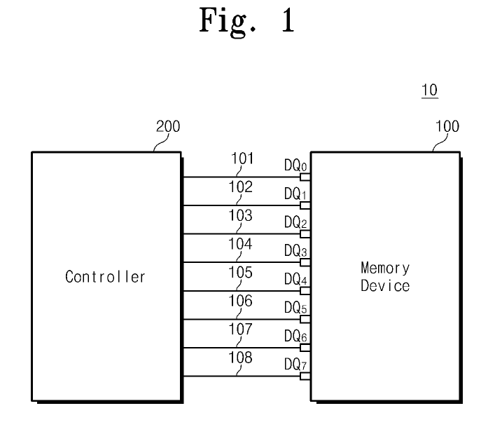

FIG. 1 shows an exemplary memory system 10 according to one embodiment.

Referring to FIG. 1, the memory system 10 may include a memory device 100 and a controller 200. The memory device 100 includes eight terminals DQ0˜DQ7 to interface with the controller 200 to receive and transmit data. Other information, such as command information and address information may also be transmitted on these terminals, or other terminals (not shown) depending on the design of the memory system 10. As such, data input into the memory device 100 (input data) via the controller 200 may be input through eight input channels 101˜108. Terminals DQ0˜DQ7 may be, for example, data pins, solder balls, or other contacts capable of transferring input data. The memory device 100 of X8 configuration having eight terminals in FIG. 1 is illustrated, but the configuration of the terminals is not limited to such an embodiment. Different numbers of terminals may be used (e.g., 16, 32, etc.). The terminals DQ0˜DQ7 may be commonly used to interface input data into the memory device 100, including content data, and/or mask data. That is, in the embodiment shown in FIG. 1, eight terminals are used to input all of the mask data and non-mask data to memory device 100. Non-mask data is typically data to be written to the memory of memory device 100 (referred to herein as “content data”). Thus, the memory device 100 and the controller 200 do not need an additional terminal for masking information. In the example shown in FIG. 1, all terminals DQ0˜DQ7 are commonly shared to send content data and mask data. However, the number of shared terminals out of terminals DQ0˜DQ7 may be changeable according to the number of bytes to be masked.

Also the memory device 100 may be one of volatile memory devices, such as DRAM (Dynamic RAM), SRAM (Static RAM), and VRAM (Video RAM), and one of non-volatile memory devices, such as Flash Memory, PRAM (Phase change RAM), and RRAM (Resistive RAM), etc.

The controller 200 may send commands to the memory device through terminals DQ0˜DQ7 or through separate command pin(s) (not shown) so that it controls overall operation of the memory device 100. The controller 200 may also send input data including data to be written to the memory device (e.g., content data) and mask data. For example, the controller 200 may generate write commands that include information about data mask operation and may send the commands to the memory device 100. Write commands may include, for example, a first write command indicating a write without a data mask operation, a second write operation indicating a write with a 1-byte data mask operation and a third write command, indicating a write operation with multi-byte data mask operation.

In one embodiment, the controller 200 sends mask data DM0˜DM7 and/or content data D0˜D7 through terminals DQ0˜DQ7, which may be data pins. For example, in one embodiment, the controller sends input data to data terminals DQ0˜DQ7 synchronously with a clock signal (e.g., the rising and/or falling edge of a clock pulse). Each clock signal may be termed a Unit Interval (UI). If the transmission speed of the mask data DM0˜DM7 is the same as that of the data when the memory system is operated at a high data rate (e.g., over 4 Gbps), the mask data DM0˜DM7 may contain errors. Thus, in one embodiment, to reduce the possibility of error, the mask data DM0˜DM7 may be transferred for a time period covering two consecutive UIs, so that the period of transferring of the mask data may be twice the period of that of the input data. Although an example of two periods is given, the relationship between the period of transferring of the data mask and the input data is not limited as such but may be other integral multiples of the input data period, including a multiple of 1.

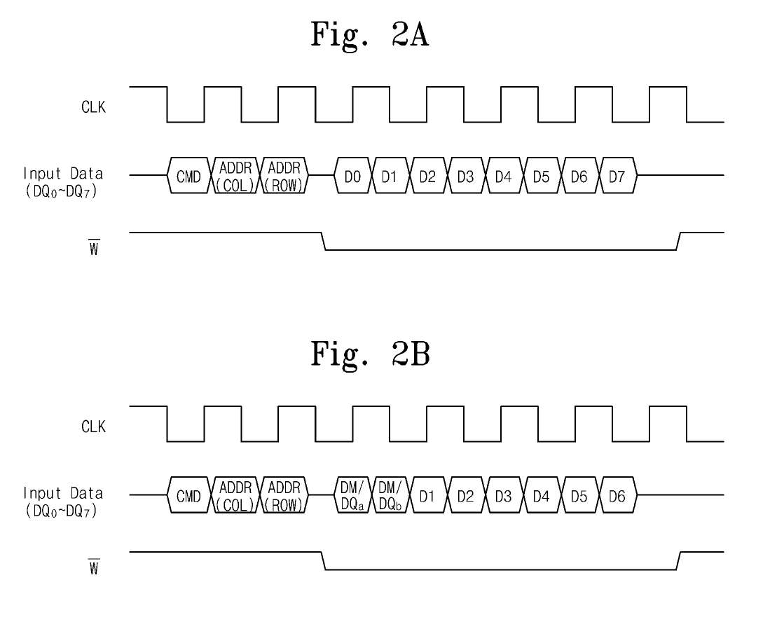

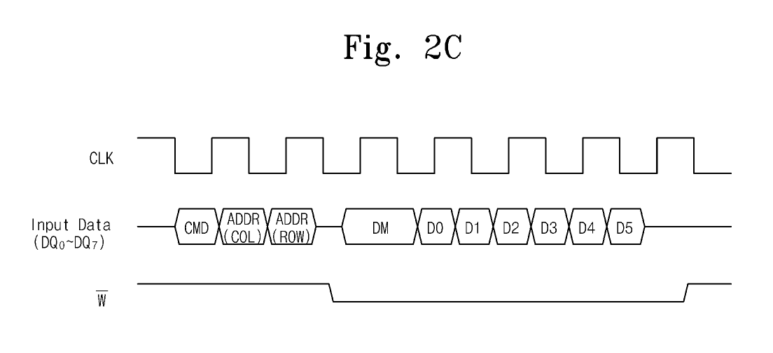

FIGS. 2a-2c depict exemplary timing diagrams for the input data for no masking, 1-byte masking, and 2-byte masking operations discussed below.

For example, FIG. 2a is a timing diagram illustrating a timing sequence for a 0-byte masking (i.e. no masking) operation for writing data to a memory, consistent with exemplary embodiments. For example, FIG. 2a depicts a clock signal (clk), an input data signal (DQ0˜DQ7) and a write enable signal “w.” As shown in FIG. 2a, input including command (CMD), address (ADDR), and content data D0˜D7 are transferred from the controller 200 to the memory device 100 through eight channels 101˜108, during a plurality of clock cycles. In one embodiment, the command and address are transferred during a first set of clock cycles. The command may include, for example, a write command, and the address may include, for example, a start address including row and column addresses in memory at which to begin storing data.

In one embodiment, after the command and address are transferred, content data D0˜D7 is transferred during one “burst,” such that the entire set of data D0˜D7 is transferred with only one command and address input. The burst can be transferred during a pre-determined number of UIs, such as, for example, a set number of clock cycles or clock edges. In one embodiment, for example, a burst includes data sent during eight clock edges (e.g., eight bytes of data, one byte per clock edge). Such a burst therefore has a burst length of eight. A burst including data send during four clock edges would have a burst length of four. As shown in FIG. 2a, after the CMD and ADDR are received, a write is enabled (e.g., by toggling a write enable terminal low), such that during one burst of burst length eight, eight bytes of data, D0˜D7, are transferred to the memory device 100. Data D0˜D7 is then written to the memory at memory locations having address locations having a known relationship to the received address ADDR. For example, data D0 may be written to a memory location having address ADDR, and data D1˜D7 may be written to locations ADDR+1˜ADDR+7, respectively.

FIG. 2b is a timing diagram illustrating a timing sequence for a 1-byte masking operation for writing data to a memory, consistent with exemplary embodiments. As shown in FIG. 2b, a command and address may initially be received by the memory device, similar to FIG. 2a described above. However, the command may include an instruction for 1-byte masking (described further below). When such a command is included, the memory device 100 receives a burst of data (which may have the same burst length as in the no masking example described above) wherein some of the data D0˜D7 is mask data, and some is content data. For example, in FIG. 2b, each of the first two UIs includes mask data DM as well as content data D0, and the remaining six UIs include content data D1˜D6. Thus, after the CMD and ADDR is received, write is enabled (e.g., low), such that during one burst of burst length eight, seven bytes of content data, D0˜D6, and one byte of mask data, are transferred to the memory device 100. This content data D0˜D6 is then written to the memory locations based on, for example, the mask data and the ADDR in the memory device 100.

FIG. 2c is a timing diagram illustrating a timing sequence for a 2-byte masking operation for writing data to a memory, consistent with exemplary embodiments. As shown in FIG. 2c, a command and address may initially be received by the memory device, similar to FIGS. 2a and 2b described above. However, the command may include an instruction for 2-byte masking (described further below). When such a command is included, the memory device 100 receives a burst of data (which may have the same burst length as in the no masking and 1-byte masking examples described above), wherein some of the data received during the burst is mask data, and some is content data. For example, in FIG. 2c, each of the first two UIs includes only mask data DM, and the remaining six UIs include content data D1˜D6. Thus, after the CMD and ADDR are received, write is enabled (e.g., by toggling a write enable terminal low), such that during one burst of burst length eight, six bytes of content data, D0˜D5, and two bytes of mask data, are transferred to the memory device 100. This content data D0˜D5 may then be written to the memory at a memory location based on, for example, the mask data and the ADDR in the memory device 100.

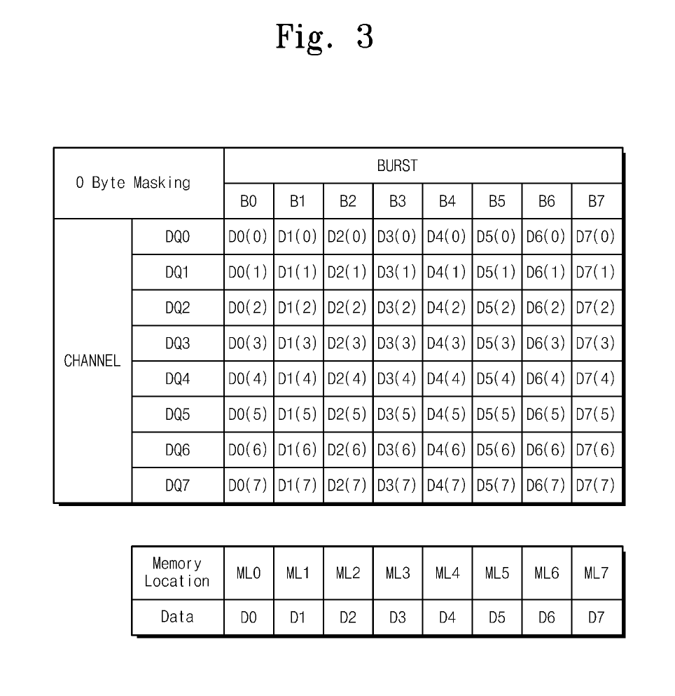

FIGS. 3, 4a, 4b, 5a, 5b, 6, 7a, and 7b depict additional masking operations according to the disclosed embodiments.

FIG. 3 shows an exemplary method of transferring input data including content data and no mask data in a memory system according to one embodiment.

Referring also to the examples shown in FIGS. 1 and 2a, FIG. 3 shows an exemplary embodiment where content data does not include any mask data, so that all of the data received during each UI of a burst is stored in a memory device. The example of FIG. 3 shows eight input terminals DQ0˜DQ7, and shows a burst having a burst length of 8 received during burst time periods B0˜B7 respectively (e.g., corresponding to eight consecutive UIs). During each UI of the burst, one byte of content data is input to memory device 100. The content data is depicted as byte D0 (D0(0)˜D0(7)) transferred at UI B0, byte D1 (D1(0)·D1(7)) transferred at UI B1, and so on through byte D7. As shown, in the no masking scenario, all of the bytes received during the burst are stored in memory. FIG. 3 shows, for example, that byte D0 is stored in memory location ML0, byte D1 is stored in memory location ML1, and so on through byte D7. In one embodiment, memory locations ML0˜ML7 have memory addresses ADDR+0˜ADDR+7, respectively. However, ML0˜ML7 may have other addresses having some predetermined relationship with ADDR.

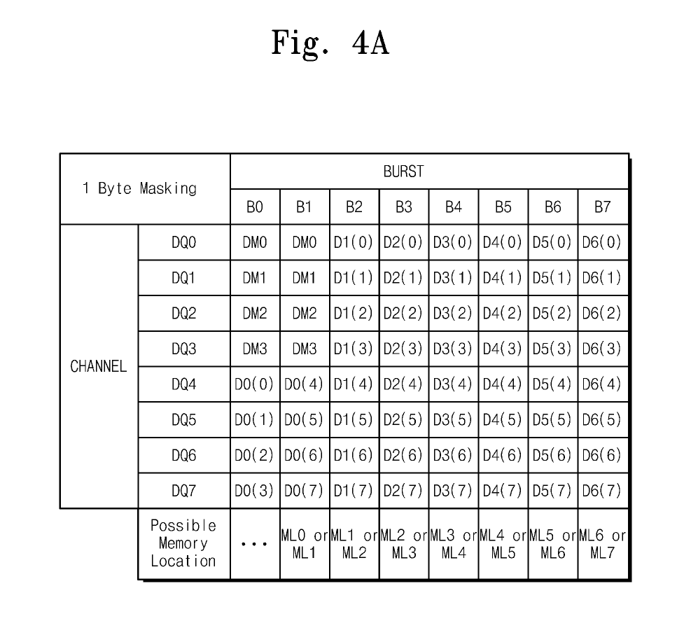

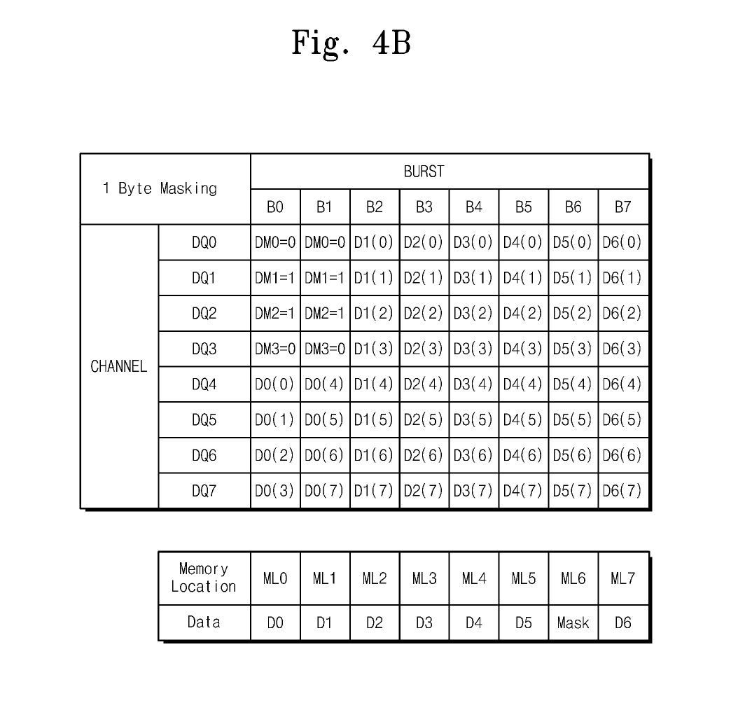

FIG. 4a shows an exemplary method of transferring input data including mask data and content data in a memory system of according to one embodiment.

Referring to the examples shown in FIGS. 1 and 2b, FIG. 4a shows a scenario where input data including mask data DM0˜DM3 and content data D0˜D6 are transferred from the controller 200 to the memory device 100 through eight channels 101˜108, during a plurality of UIs B0 to B7 during a data burst of burst length 8. For example, mask data DM includes four bits (DM0˜DM3) transferred during the first two UIs B0 and B1, content data D0 includes eight bits (D0(0)˜D0(7)) transferred during the first two UIs B0 and B1, content data D1 includes eight bits (D1(0)˜D1(7)) transferred during the third UI B2, content data D2 includes eight bits (D2(0)˜D2(7)) transferred during the fourth UI B3, etc. In the example of FIG. 4a, during a burst length of 8, where eight bits of input data to the memory device 100 during each UI, one byte of input data is transferred every UI, so that eight bytes of input data are transferred to the memory device 100 during every burst. As such, regardless of whether a no mask or a 1-byte mask scenario applies, the memory device still receives a data burst of length 8 such that no adjustments need to be made for data to be received at the memory device 100. A standard burst length of 8 may be used to make memory system compatible with other systems. Thus, in one embodiment, eight bytes of data are written to memory for each standard burst length of eight. However, it should be emphasized that other embodiments may be applicable to other burst lengths, such as 4, 16, and 2ⁿ, or to bursts having programmable (e.g., by a command) burst length, or to bursts having an indeterminate burst length (e.g., determined by a control which toggles the memory device for each new burst to be received). In the embodiment depicted in FIG. 4a, mask data DM0˜DM3 is transferred at first UI B0 and second UI B1 through data pins DQ0˜DQ3. The mask data at first UI B0 may have the same value of the mask data at second UI B1.

The mask data DM0˜DM3 may be 4-bit encoded data so that it may have 16 possible values when decoded in the memory device 100. In this way, seven bytes of content data may be transferred along with one byte of mask data during the burst. The 4-bit encoded mask value can then be used to determine which location of a memory to mask when writing the content data to memory cells.

For example, a first byte of content data D0(0)˜D0(7), as shown in FIG. 4a, is transferred at first UI B0 and second UI B1 through data pins DQ4˜DQ7. A second byte of content data D1(0)˜D1(7) is transferred at third UI B2. Like this, each byte of content data is transferred at every UI from third UI B2 to last UI B7. As a result, one byte of mask data and seven bytes of content data are transferred during the burst. As such, all or part of the four bits of mask data may be used to determine which of the memory locations to mask when writing the remaining seven bytes of content data to memory. Although the mask data is described above as being input during the first two UIs, it may alternatively be input during two other UIs, such as UIs B6 and B7 at the end of the burst instead of at the beginning of the burst. In addition, although duplicating the 4-bit mask data across two UIs is described above, the 4-bit mask data could be input only during one UI, thereby leaving available four additional bits that could be used for other purposes. Similarly, it may be possible to use only three of the mask data bits to perform the data masking operation in the 1-byte masking operation depicted in FIG. 2a and to select one of eight memory locations to mask. As such, additional DM bits not used for the masking operation may be used for other purposes (e.g., such as a check bit or parity bit).

The memory device 100 using the method of transferring input data including content data and the encoded mask data as shown in FIG. 4a may have a data aligner to decode the encoded mask data and to align input data. For example, FIG. 4b depicts an exemplary data write to memory, where the content data D0˜D6 received in UIs B0˜B7 is written to allocated memory location block ML˜ML7 in memory device 100, and the mask data DM0˜DM3 is used to determine which seven memory locations of ML0˜ML7 should be written to with content data D0˜D6 and which one memory location should be masked.

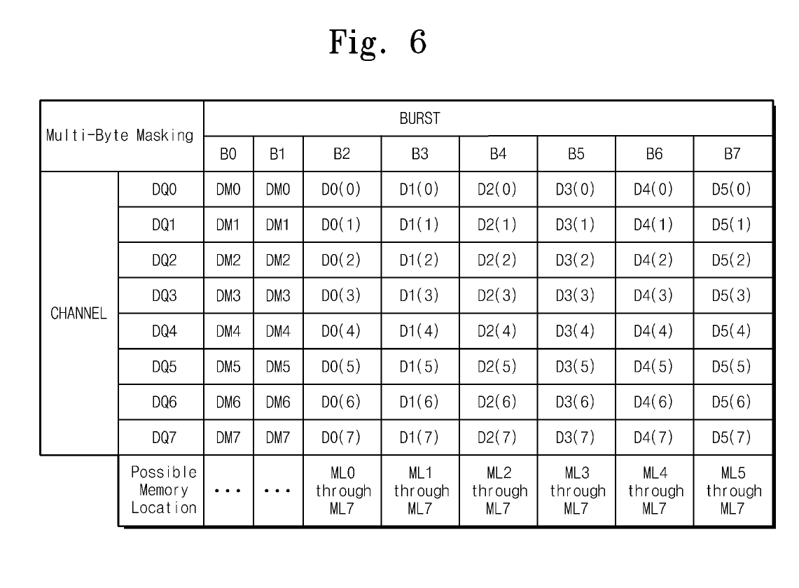

For example, as shown in FIG. 4b, data mask bits DM0˜DM3 are 0110 respectively. Using this value, a data aligner may determine which one of the eight allocated memory locations ML0˜ML7 should be masked, and which of the memory locations should be written to with the content data D0˜D6 received in UIs B0˜B7. For example, in one embodiment, a data aligner can read the first three data mask bits DM2, DM1, and DM0 (1,1,0 respectively), and can decode this value to mean that the memory location ML6 should be masked, and the remainder of the memory locations written to with content data D0˜D6. Any suitable decoding algorithm can be used (e.g., converting three bits with a decimal value of X to eight bits having all 1's except for a 0 bit in the Xth bit location). In this example, as a result, content data D0 is written to memory location ML0, content data D1 is written to memory location ML1, content data D2 is written to memory location ML2, content data D3 is written to memory location ML3, content data D4 is written to memory location ML4, content data D5 is written to memory location ML5, memory location ML6 is masked (i.e., no data is written), and content data D6 is written to memory location ML7. In one embodiment, for example, the memory locations may be eight consecutive memory locations following a start memory address ADDR designated by the controller. However, the exemplary memory locations needn't be consecutive or even ordered locations in the memory device 100, but may be any eight memory locations pre-allocated for the content data input in UIs B0˜B7. A further embodiment of the data aligner will be described in more detail later in connection with FIG. 6.

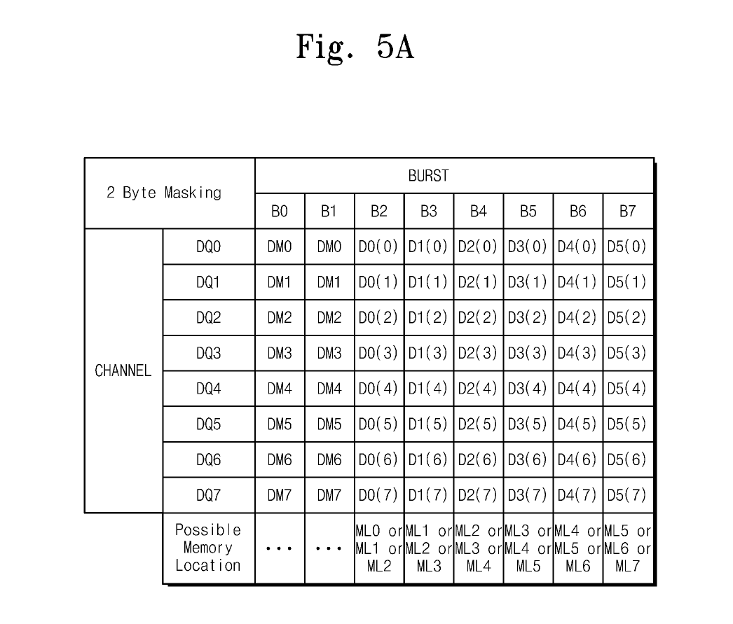

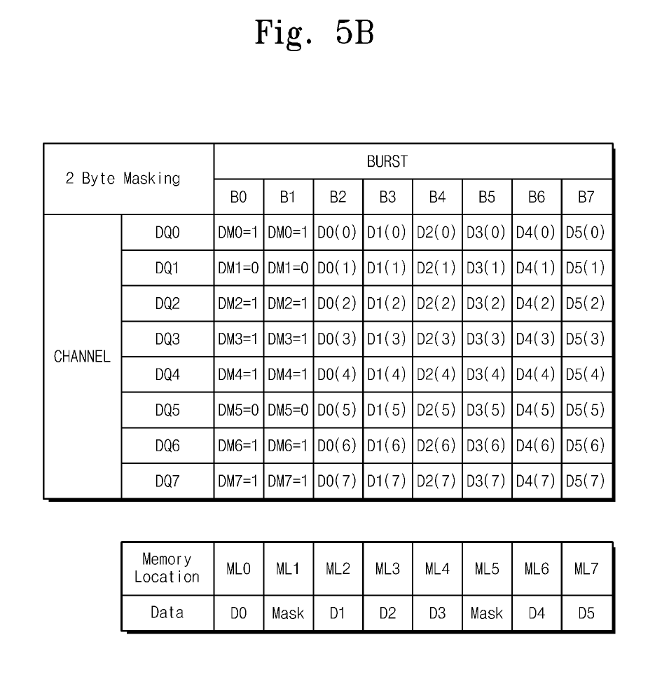

FIGS. 5a and 5b show an exemplary method of transferring input data including mask data and content data in a memory system according to another embodiment.

As shown in FIG. 5a, mask data DM0˜DM7 is transferred during each of two UIs B0 and B1, through all of data pins DQ0˜DQ7 so that at least two bytes of data may be masked. In one embodiment, to reduce the possibility of error due to lost mask data, each of mask data bits DM0˜DM7 at B0 is the same value as mask data bits DM0˜DM7 at B1. For masking two bytes, as shown in FIG. 5a, each byte of content data may be transferred at every UI from third UI B2 to last UI B7 through data pins DQ0˜DQ7.

FIG. 5b depicts an exemplary data write to memory, where the content data D0˜D5 received in UIs B2˜B7 is written to allocated memory locations ML0˜ML7 in memory device 100, and the mask data DM0˜DM7 is used to determine which six memory locations of ML0˜ML7 should be written to with content data D0˜D5 and which two memory locations should be masked.

For example, as shown in FIG. 5b, data mask bits DM0˜DM7 are 10111011 respectively. Using this value, a data aligner may determine which two of the eight allocated memory locations ML0˜ML7 should be masked, and which of the memory locations should be written to with the content data D0˜D5 received in UIs B2˜B7. For example, in one embodiment, a data aligner can decode the 8-bit data mask so that DM0 corresponds to the memory location ML0, DM1 corresponds to memory location ML1, etc. As such, in the example of FIG. 5b, where a “1” mask data bit indicates no mask and a “0” mask data bit indicates mask, content data D0 is written to memory location ML0, memory location ML1 is masked (i.e., no data is written), content data D1 is written to memory location ML2, content data D2 is written to memory location ML3, content data D3 is written to memory location ML4, memory location ML5 is masked (i.e., no data is written), content data D4 is written to memory location ML6, and content data D5 is written to memory location ML7. As such, during the same burst length as described in the scenarios of FIGS. 3 and 4a, six bytes of content data and two masked bytes can be stored into eight memory locations in a memory cell array of memory device 100.

As in the examples above, the exemplary memory locations needn't be consecutive or even ordered locations in the memory device 100, but may be any set of eight memory locations pre-allocated for the content data input in UIs B0˜B7. In addition, the mask data need not be duplicated during two UIs. As such, a 2-byte mask may be affected with only a single UI of mask data and seven UIs of content data, wherein one of the UIs of content data comprises default data or “don't care” values and is not input into the memory. In one embodiment, for example, default data may be chosen to reduce noise. For example, the default data may be DC balanced data, such that the number of 0's and 1's in the byte of data have a desired ratio to reduce current fluctuations in the input buffer between received bytes (e.g., four 0's and four 1's).

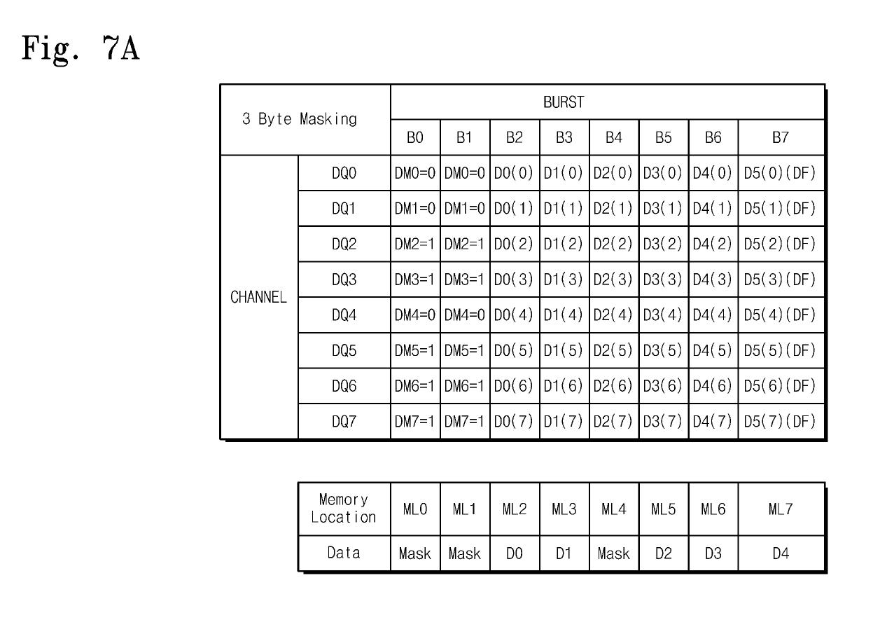

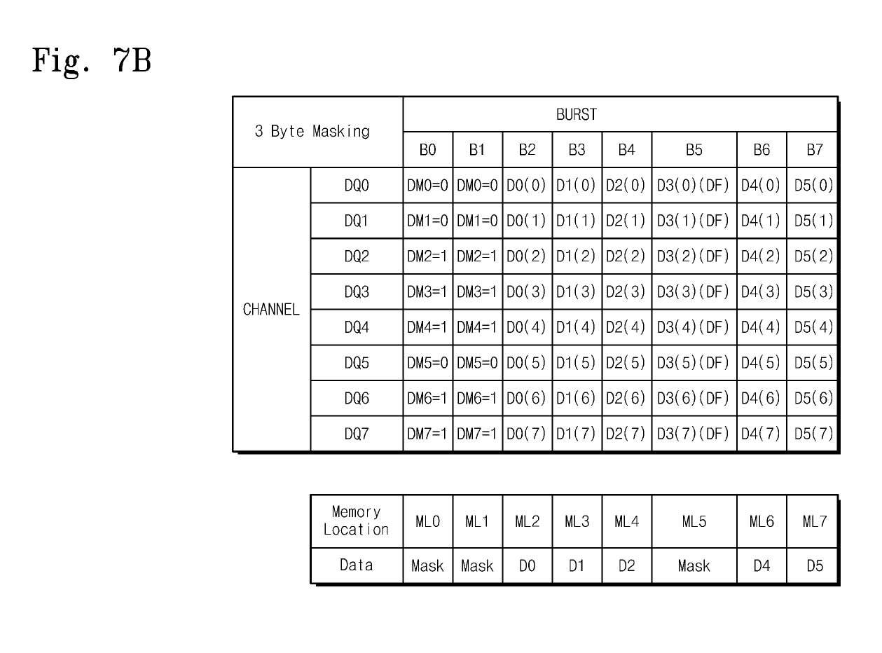

FIG. 6 shows an exemplary method of transferring input data including mask data and content data for a multi-byte masking operation according to one embodiment. In the example of FIG. 6, mask data DM0˜DM7 is transferred during each of two UIs B0 and B1, through all of data pins DQ0˜DQ7 so that at least two bytes of data may be masked. In one embodiment, each mask data bit DM0˜DM7 at B0 is the same value as mask data bit DM0˜DM7 at B1. For masking two bytes, as described above in connection with FIGS. 5a and 5b, each byte of content data may be transferred at every UI from third UI B2 to last UI B7 through data pins DQ0˜DQ7. In addition, for masking three or more bytes, five or fewer bytes of content data and one or more byte of predetermined or referenced data (i.e., default or “don't care” bits) may be transferred from third UI B2 to last UI B7. In this case, the order of transferring data and the predetermined data may be varied according to established criteria. For instance, memory system 10 may be programmed so that data at a particular UI within the sequence is considered to include “don't care” or default data that is not to be written to memory. This is explained in more detail below in connection with FIG. 7a and FIG. 7b.

FIG. 7a shows an exemplary method of transferring input data including mask data and content data for a 3-byte mask operation according to one embodiment. Referring to FIG. 7a, mask data DM0˜DM7 with value of “00110111” is transferred at UIs B0 and B1. In one embodiment, using this value, a data aligner may determine which three of the eight allocated memory locations ML0˜ML7 should be masked, and which of the memory locations should be written to with the content data D0˜D4 received during UIs B2˜B7. Because only five bytes of data will be written to memory but six content data bytes are received by the memory device 100 (one byte for each UI B2˜B7), one of the received content data bytes can be ignored. This byte could be considered a “don't care” byte, or a “default” byte, which can contain any predetermined or random set of bits, and does not get written to the memory. The location of the default data content byte within the burst length can be pre-determined to be one of any of the six data content bytes received in bursts B2˜B7.

For example, in one embodiment, a data aligner can decode the 8-bit mask data so that DM0 corresponds to the memory location ML0, DM1 corresponds to memory location ML1, etc. As such, in the example of FIG. 7a, where a “1” mask data bit indicates no mask and a “0” mask data bit indicates mask, memory location ML0 is masked (i.e., no data is written), memory location ML1 is masked (i.e., no data is written), content data D0 is written to memory location ML2, content data D1 is written to memory location ML3, memory location ML4 is masked (i.e., no data is written), content data D2 is written to memory location ML5, content data D3 is written to memory location ML6, and content data D4 is written to memory location ML7. Because three bytes of data are to be masked in this operation, the eighth UI B7 of this eight burst length operation is filled with default or “don't care” bits D5, and the data aligner operates such that D5 is not written to memory. As in the example above, the exemplary memory locations needn't be consecutive or even ordered locations in the memory device 100, but may be any set of eight memory locations pre-allocated for the content data input in bursts B0˜B7. In addition, the mask data need not be duplicated during two UIs. As such, a multi-byte mask may be affected with only a single UI of mask data and seven UIs of content data, wherein two of the UIs of content data are not input into the memory (i.e., comprise “don't care” or default values).

Although the “default” content data byte in FIG. 7a is the byte received in UI B7, any of the bytes could be designated as the default byte. FIG. 7b depicts a method of transferring input data similar to that of FIG. 7a, but where the “default” data content byte is designated by the mask data. In this example, the mask data DM indicates that memory locations ML0, ML1, and ML5 are to be masked. Sequentially received content data D0, D1, and D2 are aligned to be written to memory locations ML2, ML3, and ML4 respectively. The next byte received, D3, is therefore recognized as corresponding to a memory location to be masked (ML5). Thus, this D3 data may be disregarded, or alternatively aligned with ML5 but prevented from being written to ML5 through masking control circuitry (e.g., preventing a column select signal from activating a data transfer to memory cells of D5). As such, the data aligner will know to mask the data received during the UI B5 and will not write that data to memory. For example, in one embodiment, for 3-byte or higher data masking, the default byte of content data can correspond to one of the masked “0” bits in the mask data, such that regardless of the data bits in the default byte, those data bits will be masked when the memory is written to. As shown in FIG. 7b, memory location ML5 is masked based on the data mask byte 00111011, and the data received in UI B5 (D3) comprises default data.

For masking four or more bytes, four bytes or fewer of content data may be transferred using four or fewer UIs out of B2 to B7 and at least two bytes of default data may be transferred using two or more UIs out of B2 to B7.

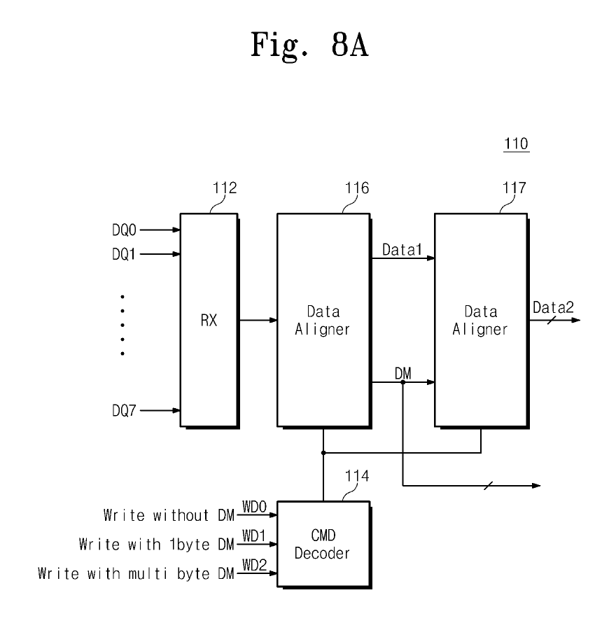

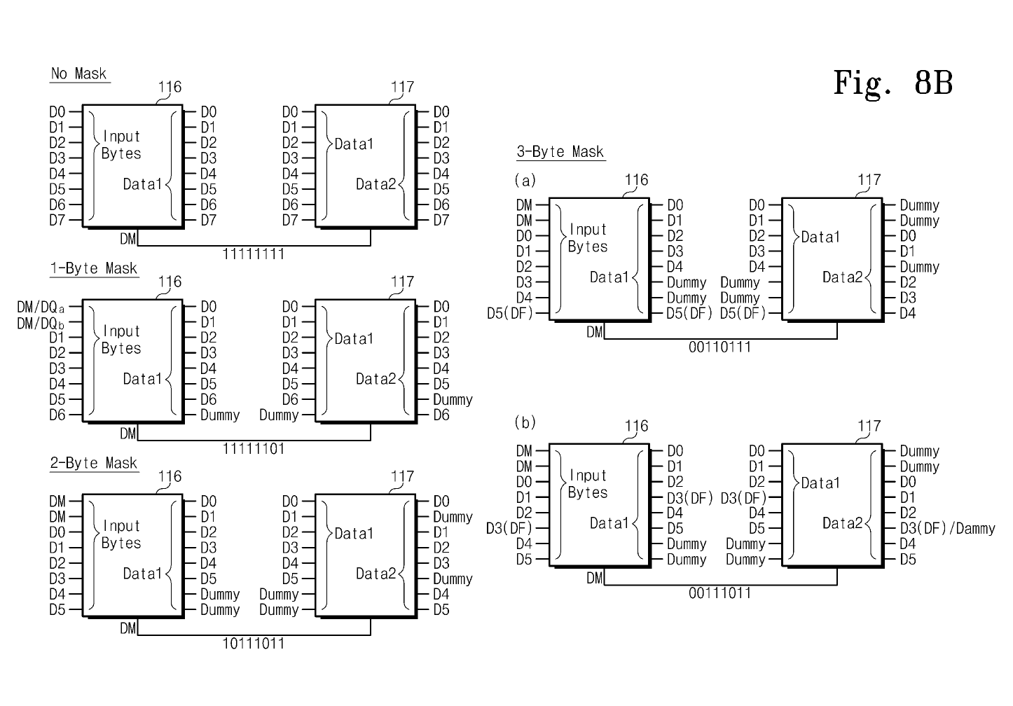

FIG. 8a shows an exemplary data input part of a memory device in accordance with one embodiment.

Referring to FIG. 8a, the data input part 110 may include a data receiver 112, a command decoder 114, a data aligner 116, and a data re-aligner 117. Generally, a data aligner or re-aligner is a device that receives an input including a set of data, and aligns the data in order to produce an output having a certain byte size and arrangement. Data aligners may use different mechanisms to re-align the input data. An exemplary data aligner including exemplary devices for implementing data alignment is described, for example, in U.S. Pat. No. 5,922,066, which is incorporated herein by reference in its entirety. The data input part of FIG. 8a is discussed below for an exemplary system in which eight bytes of input data are successively inputted through eight data pins during a burst length of 8. Other arrangements having different data sizes, numbers of input terminals, or burst lengths are possible.

The data receiver 112 receives input data including content data and mask data during the burst through data pins DQ0˜DQ7 from the controller 200 and sends the input data to the data aligner 116.

The command decoder 114 receives one of three write commands, write command without mask operation WD0, write command with 1 byte data mask operation WD1, and write command with multi-bytes mask operation WD2, and decodes the received write command, and outputs a control signal to the data aligner 116 and the data re-aligner 117. The three commands may be provided over the same input(s) to the command decoder 114. When the write command without mask operation WD0 is decoded, the input data does not have mask data. When the write command with 1-byte mask operation WD1 is decoded, the input data has one byte of mask data and seven bytes of content data. When the write command with a multi-byte mask operation WD2 is decoded, the input data has at least two bytes of mask data and six bytes or less than six bytes of content data. For a multi-byte mask operation, the write command for multi-byte mask operation may include an instruction indicating that at least one of the UIs will include at least one byte of predetermined default data.

The data aligner 116 divides and aligns input data into data Data1 to be written into memory cells and mask data DM in response to the control signal from the command decoder 114. That is, data aligner 116 separates the content data from the mask data, and outputs the content data as Data1, and outputs the mask data as DM. Thus, if the control signal indicates a write without data masking, then all eight bytes of data input into data aligner 116 are passed to the output of data aligner 116 as Data1 (they may be passed, for example, serially or in parallel). However, if the control signal indicates a write with 1-byte or multi-byte masking, then some of the input data of data aligner 116 is parsed out and is treated as mask data and output as DM and the remainder is treated as content data and is output as part of Data1 (e.g., with the other part of Data1 comprising dummy data).

In one embodiment, the aligned mask data DM is successive eight bits of mask data that does not include data to be written in the memory cells and includes information of which memory locations are to be masked. For instance, in one embodiment, when the value of the aligned mask data DM is “01111111”, the first byte of memory to which the content data is to be written is masked. When the value of the aligned mask data DM is “00110111” first, second, and fifth bytes of memory to which the content data is to be written are masked. In one embodiment, to effectuate masking of appropriate bytes of memory, the aligned mask data DM is also sent to a memory core including the memory cell to be written to such that if the value of the aligned mask data DM is “0,” then a column selection signal is prevented from being enabled so that the column of memory cannot be written to.

The data re-aligner 117 receives aligned content data Data1 in response to the control signal and, using the aligned mask data DM, outputs re-aligned Data2 to the memory core. That is, the data re-aligner 117 changes Data1 into Data2, which may include pre-set dummy data at a location of bytes to be masked as indicated by the mask data.

For example, in a 1-byte mask operation such as described in FIGS. 4a and 4b, data aligner 116 receives eight bytes of data in one burst. Seven of those bytes (D0 received at UIs B0 and B1, D1 received at UI B2, D2 received at UI B3, D3 received at UI B4, D4 received at UI B5, D5 received at UI B6, and D6 received at UI B7) are content data to be written to memory, and one of those bytes (DM) is mask data. Data aligner 116 then aligns those bytes, which were received in an order of DM/DOa, DM/DOb, D1, D2, D3, D4, D5, D6, such that, in one embodiment, it outputs bytes D0, D1, D2, D3, D4, D5, D6, and a dummy byte as Data1 to data re-aligner 117. Data aligner 116 also aligns the mask data so that it is output as DM to data re-aligner 117. When data re-aligner receives the mask data DM and the content data Data1, it then re-aligns the data such that the data bytes D0˜D6 are placed in an order according to the mask data, such that, for instance, if the mask data is 11111101, then the first byte of data output from data re-aligner 117 is D0, the second byte is D1, the third byte is D2, the fourth byte is D3, the fifth byte is D4, the sixth byte is D5, the seventh byte is dummy data, and the eighth byte is D6. As such, eight bytes of data output from the data re-aligner 117 are properly aligned to be written to the memory cell array. Examples of this and other data alignment schemes are shown in FIG. 8b. The data inputs and outputs to the data aligner and data re-aligner are represented as having a parallel arrangement for ease of explanation. However, the inputs and outputs may be sequential (e.g., byte-by-byte) or a combination of sequential and parallel (e.g., the input to the data re-aligner may be byte-by-byte sequential and the output may be parallel (e.g., 8 bytes)).

In a 3-byte mask, in one embodiment, if the aligned mask data DM is “00110111”, Data1 may include, for example, five bytes of data to be written to memory, two bytes of dummy data and one byte of default data. Data2 may include dummy data at the first byte and second byte, dummy or default data at the fifth byte, and may include data bytes received at bursts B2˜B6 in the remaining bytes. The eight bytes of data may then be sent to memory cells in the memory device 100, with the first, second, and fifth bytes being masked. In one embodiment, when the value of the aligned mask data DM is “0”, the corresponding memory location is not written to. On the contrary, when the value of the aligned mask data DM is “1”, the re-aligned Data2 for that slot is written to the memory cell. In one embodiment, to effectuate masking of appropriate bytes of memory, the aligned mask data DM indicates the location of the memory cell such that if the value of the aligned mask data DM is “0,” then a column selection signal is prevented from being enabled so that the column of memory cannot be written to.

FIG. 8b further illustrates exemplary processes of data alignment that occur in the data aligner 116 and re-aligner 117 of FIG. 8a, for situations involving no masking, 1-byte masking, 2-byte masking, and 3-byte masking, such as described above.

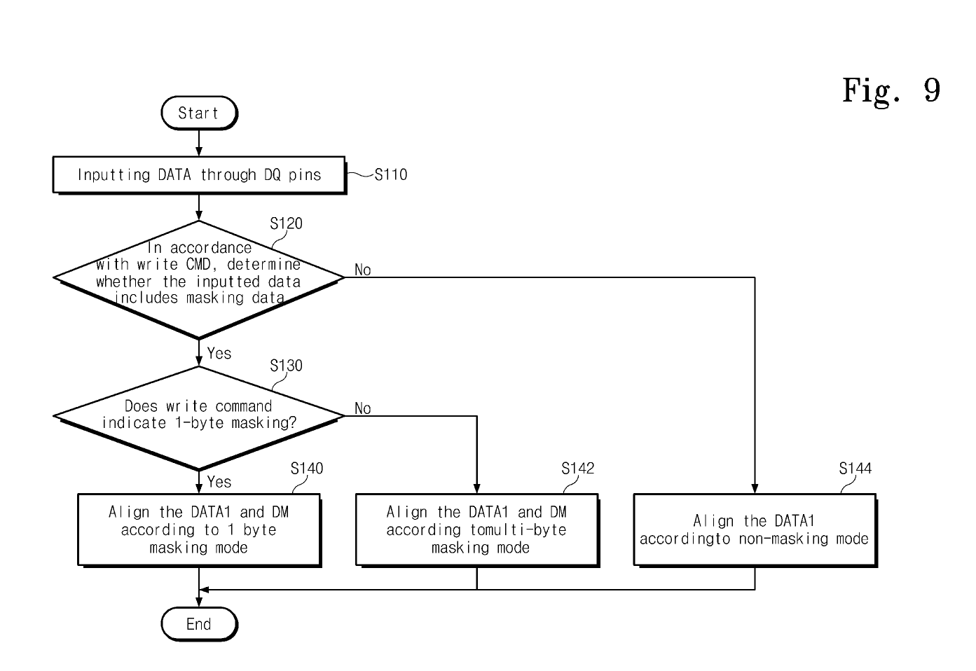

FIG. 9 is a flow chart illustrating an exemplary method of aligning input data according to one embodiment. The method of aligning input data including mask data and content data will be described with reference to FIGS. 1 to 8.

In step S110, the receiver 112 of the memory device 100 receives input data through the plurality of data pins DQ0˜DQ7 from the controller 200 for a write operation. The input data is inputted during the plurality of UIs B0˜B7, which constitute one burst.

In step S120, the memory device 100 determines if input data has mask data or not according to the result of decoding a write command inputted from the controller. If the decoded write command indicates no mask operation such that the input data does not include any mask data, the data aligner 116 outputs the input data as Data1 to be written into the memory cells and also outputs “11111111” as DM to indicate that none of the content data should be masked (step S144). This may be referred to non-masking mode in which “11111111” causes data re-aligner 117 to write into the memory cells without masking operation.

If the memory device determines that the write command is for 1-byte mask operation, then the data aligner 116 and the data re-aligner 117 align the data into Data2 including one byte of dummy data and the remaining seven bytes of the content data, in response to the mask data.

Also the memory device may determine that the write command is for more than one byte of masking. If so, the data aligner 116 and the data re-aligner 117 align the data into Data2 including at least two bytes of dummy data and six or fewer bytes of content data in response to the mask data.

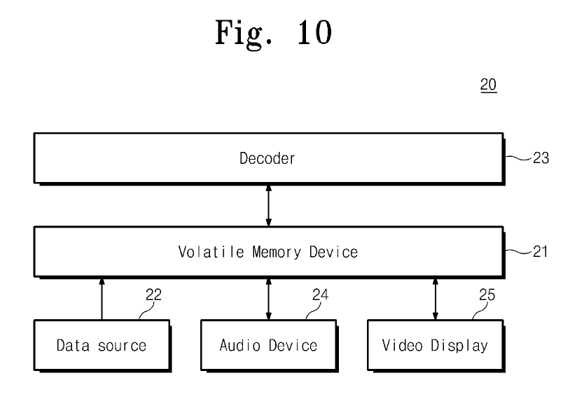

FIG. 10 is a depiction of a digital TV adopting a memory device according to one embodiment. Referring to FIG. 10, the digital TV 20 includes a memory device 21, data source 22, decoder 23, audio device 24 and video display 25.

The memory device 21, being one of volatile and non-volatile memory, may include memory cells as a bit buffer or bit bank, an audio data buffer, and/or a video data buffer. The memory device 21 may be the same that of the memory device 100 in FIG. 1, having a data input part 110 such as shown in FIG. 8a.

The data source 22 sends a compressed data to the bit buffer of the memory device. In general, the data source 22 may include a tuner that changes a received data from an external source through a cable or air into the compressed data, based on the compressed data and fit to format of compression data of digital TV. In storing data to the buffers, the digital TV 20 may use one or more of the masking operations described above.

The decoder 23 performs necessary operations for decoding the compressed data from the memory device 21. During a decoding operation, the decoder 23 may use a decoding buffer so that decoded data has desirable image size. For instance, the decoder 23 may be a MPEG4 decoder. The decoding buffer stores the decoded audio and video data into an audio data buffer and a video data buffer of the memory device 21. The audio data buffer uses 1M bit of the memory device and the video data buffer needs from 16M bit to 32M bit depending on a screen size of the digital TV 20.

The audio device 24 receives sound data from the audio data buffer and generates sound. The video display 25 receives video data from the video data buffer and generates image to be displayed on the screen of the digital TV 20.

The method of transferring input data including mask data according to the disclosed embodiments doesn't use additional pins to send the mask data but commonly uses data pins or other terminals to send the mask data. Also, the mask data having a same value for two UIs may be transferred from the controller to the memory device. In addition, the disclosed embodiments permit data masking of any desired number of bytes, while still using the same, standard burst length that would be used in a 9-pin data masking system. Thus, the method according to the disclosed embodiments improves the limitation of the number of pins and detects and corrects an error in the mask data caused by high speed transmission using general error detecting and correcting method, while providing compatibility with existing standard burst length systems.

While example embodiments have been disclosed herein, it should be understood that other variations may be possible. Such variations are not to be regarded as a departure from the spirit and scope of example embodiments of the present application, and all such modifications as would be obvious to one skilled in the art are intended to be included within the scope of the following claims.

What is claimed is:

1. A method of transferring input data during a burst having a burst length of N, the method comprising:
transferring to a memory device data for each of a plurality of unit intervals (UIs) of the burst through a plurality of terminals, each of the transfers including D bits of input data, at least some of the input data to be written to the memory device;
transferring to the memory device mask data during the burst as part of the input data, the mask data occupying at least two UIs; and
transferring to the memory device content data during the burst as part of the input data,
wherein the mask data transferred during each of the at least two UIs has the same value.

2. The method of claim 1, wherein the burst length N is 8.

3. The method of claim 1, wherein two of the UIs include mask data and the remainder of the UIs do not include mask data.

4. The method of claim 3, wherein for each of the two UIs that include mask data, only a portion of the D bits in the UI comprise mask data and the remaining bits comprise non-mask data.

5. The method of claim 4, wherein the mask data indicates that one location of a memory where part of the input data is to be written will be masked.

6. The method of claim 3, wherein each of the two UIs that include mask data include only mask data.

7. The method of claim 6, wherein the mask data indicates that two or more locations of a memory where part of the input data is to be written will be masked, and further indicates which locations of the memory will be masked.

8. The method of claim 1, wherein the number of the plurality of terminals is 8, the burst length is 8, the mask data is transferred for two UIs, and the content data is transferred for six UIs.

10. The method of claim 8, wherein the input data includes at least one byte of default data.

11. The method of claim 10, wherein the at least 1 byte of default data is included as part of a byte of input data that does not include the mask data.

12. A method of aligning data to be stored in a memory device including a plurality of memory cells, the method comprising:
receiving input data including content data through a plurality of terminals during a plurality of Unit Intervals (UIs) comprising a burst length N, wherein the memory device is configured to receive both the content data and mask data through the same plurality of terminals; and
determining if a write command indicates a data mask operation, and
if the write command does not indicate a data mask operation, aligning the content data to be stored in N memory locations, and if the write command indicates a data mask operation, aligning the content data to be stored in fewer than N memory locations and aligning pre-set data for the remaining of the N memory locations.

13. The method of claim 12, wherein if the data mask operation is an -Mbyte mask operation, then based on the mask data, aligning N-M bytes of the input data to be stored in N-M memory locations.

14. The method of claim 13, wherein the remaining M memory locations are masked.

15. A memory device including a plurality of memory cells, comprising:
a data receiver configured to receive input data including mask data and content data during a plurality of Unit Intervals (UIs) of a burst;
a data aligner configured to divide and align the input data into the mask data and the content data in response to a control signal indicating a write command; and
a data re-aligner configured to receive the aligned mask data and the aligned content data and to realign the content data in response to the aligned mask data.

16. The memory device of claim 15, further comprising:
a command decoder configured to decode the write command, which includes one of a first write command to write without mask operation, a second write command to write with a 1-byte mask operation, and a third write command to write with multi-byte mask operation, and to output the control signal.

17. The memory device of claim 16, wherein if the write command is the first write command, the data re-aligner re-aligns the aligned content data with no dummy data.

18. The memory device of claim 16, wherein if the write command is the second write command, the data re-aligner re-aligns the aligned content data with one byte of dummy data in response to the aligned mask data.

19. The memory device of claim 17, wherein if the write command is the third write command, the data re-aligner re-aligns the aligned content data with at least two bytes of dummy data in response to the aligned mask data.

20. A memory system comprising:
a controller configured to output data to Q terminals during N unit intervals (UIs) of a burst having length N to a memory device; and
a memory device, the memory device including memory cells and configured to:
receive, through Q terminals during the burst, the data output from the controller;
receive a control signal that indicates whether any of the data received at the Q terminals during the burst is mask data; and
based on the control signal indicating that none of the data received during the burst at the Q terminals is mask data, write all of the data received through the Q terminals during the burst to the memory cells.
